(19) United States
(12) Patent Application Publication
(10) Pub. No.: US 2015/0170127 A1
(43) Pub. Date: Jun. 18, 2015

(54) APPARATUS, METHOD, AND COMPUTER PROGRAM PRODUCT FOR ESTIMATING THE POTENTIAL BENEFIT OF FUNDING A SPECIAL ACCOUNT

(71) Applicant: MasterCard International Incorporated, Purchase, NY (US)

(72) Inventors: Kenny Unser, Fairfield, CT (US); Serge Bernard, Danbury, CT (US); Nikhil Malgatti, Stamford, CT (US)

(73) Assignee: MasterCard International Incorporated, Purchase, NY (US)

(21) Appl. No.: 14/104,736

(22) Filed: Dec. 12, 2013

(51) Int. Cl. G06Q 20/22; G06Q 20/34; G06Q 20/10

(52) U.S. Cl. CPC G06Q 20/227; G06Q 20/10; G06Q 20/34

(57) ABSTRACT

Transaction data from a set of transactions is examined to identify a portion of spending in the set of transactions which is eligible for coverage by a special spending account. The set of transactions was not made with the special spending account. A funding recommendation for the special spending account is provided, based on the identified portion of the spending in the set of transactions which is eligible for the coverage by the special spending account.

### FIELD OF THE DISCLOSURE

The present disclosure relates generally to the electronic and computer arts, and, more particularly, to electronic payment data, and to special accounts such as health savings accounts and flexible spending accounts.

### BACKGROUND OF THE DISCLOSURE

The use of payment cards, such as credit cards, debit cards, and pre-paid cards, has become ubiquitous. Most payment card accounts have one or more associated physical cards; however, the use of non-traditional payment devices, such as appropriately configured “smart” cellular telephones, is increasing. A wealth of transaction data is available based on the use of payment card accounts.

A flexible spending account (FSA), also known as a flexible spending arrangement permits an eligible employee to set aside a portion of earnings to pay for qualified expenses (e.g., medical expenses, dependent care, and the like). In an FSA, funds not used by the end of the plan year are lost to the employee.

A health savings account (HSA) is a tax-advantaged medical savings account available to taxpayers in the United States who are enrolled in a high-deductible health plan; unlike an FSA, funds roll over and accumulate year to year if not spent.

### SUMMARY OF THE DISCLOSURE

Principles of the present disclosure provide techniques for estimating the potential benefit of funding a special account, such as an HSA or FSA. At least some aspects of the techniques may be facilitated by the operator of a payment card processing network or other service provider.

In one aspect, an exemplary method includes the step of examining transaction data from a set of transactions not made with a special spending account to identify a portion of spending in the set of transactions which is eligible for coverage by a special spending account. A further step includes providing a funding recommendation for the special spending account, based on the identified portion of the spending in the set of transactions which is eligible for the coverage by the special spending account.

Aspects of the disclosure contemplate the method(s) performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the disclosure or elements thereof can be implemented in the form of a computer program product including a tangible computer readable recordable storage medium with computer usable program code for performing the method steps indicated stored thereon in a non-transitory manner. Furthermore, one or more embodiments of the disclosure or elements thereof can be implemented in the form of a system (or apparatus) including a memory and at least one processor that is coupled to the memory and operative to perform exemplary method steps. Yet further, in another aspect, one or more embodiments of the disclosure or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the disclosure can provide substantial beneficial technical effects, including accurately predicting the desirable amount of funding in a special account for which overfunding and/or underfunding is undesirable.

These and other features and advantages of the present disclosure will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the disclosure;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, as well as an exemplary database, useful in connection with one or more embodiments of the disclosure;

FIG. 3 depicts a drug store selling items that are both eligible and ineligible for special account use;

FIG. 4 is a flow chart of an exemplary method, in accordance with an aspect of the disclosure;

FIG. 5 is an exemplary system block diagram, in accordance with an aspect of the disclosure; and

FIG. 6 is a block diagram of an exemplary computer system useful in one or more embodiments of the disclosure.

### DETAILED DESCRIPTION OF PREFERRED EMBODIMENTS

At least some embodiments employ data from transactions made with payment cards or other portable payment devices, to estimate the potential benefit of funding a special account, such as an HSA or FSA.

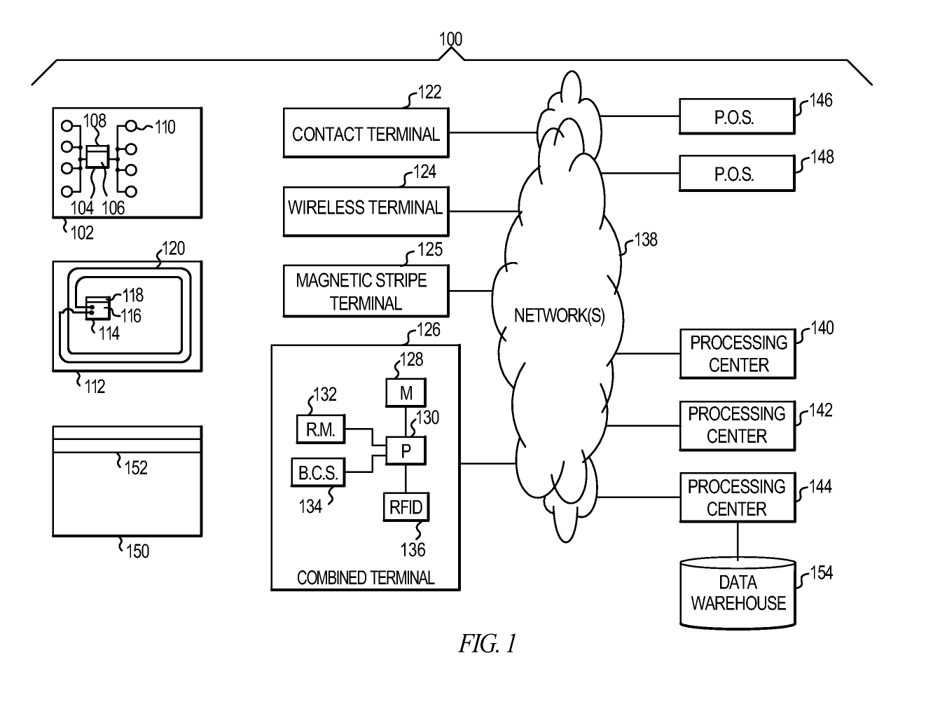

With regard to payment card and similar payments, attention should now be given to FIG. 1, which depicts an exemplary embodiment of a system 100, according to an aspect of the disclosure, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), and the like) can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present disclosure is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (trademarks of MasterCard International Incorporated, Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

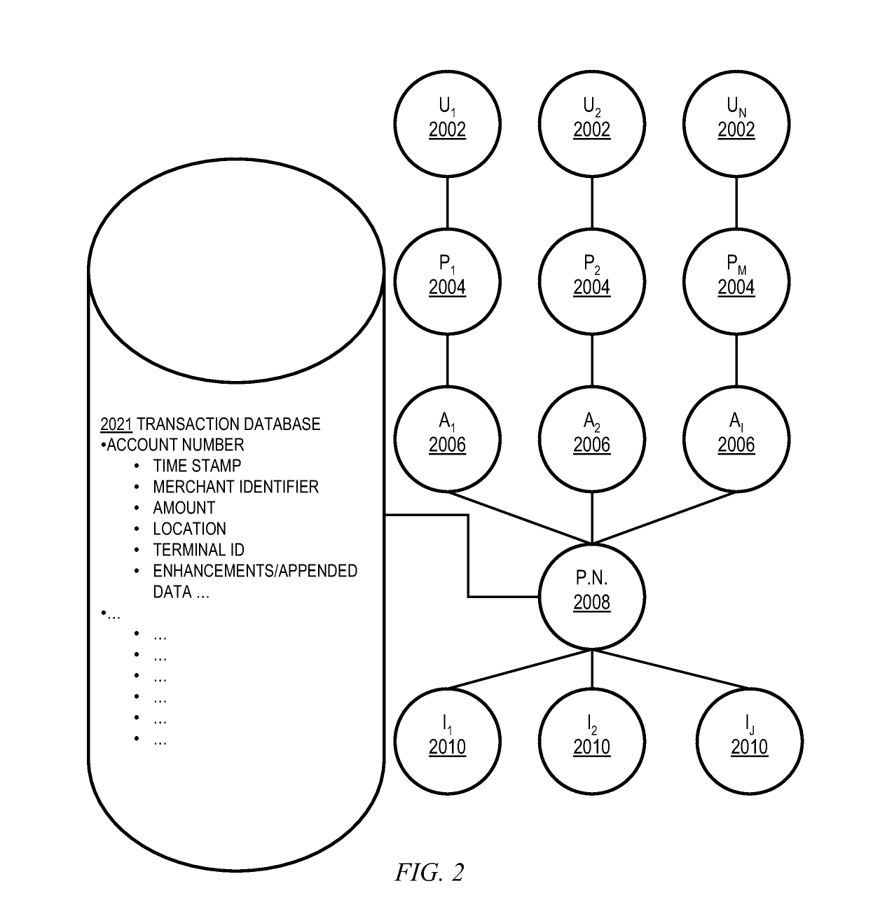

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as reader module 132 that is coupled to the processor and configured to interface with the portable apparatuses 102, 112, 150. The processor 130 can be operable to communicate with portable payment devices of a user via the reader module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification from a UPC code or RFID tag on a product to be purchased.

The above-described devices 102, 112 can be International Organization for Standardization (ISO) 7816-compliant contact cards or devices or NFC (Near Field Communications) or ISO 14443-compliant proximity cards or devices. In operation, card 112 can be touched or tapped on the wireless terminal 124 or reader module 132 (or an associated reader), which then contactlessly transmits the electronic data to the proximity IC chip in the card 112 or other wireless device.

One or more of the processing centers 140, 142, 144 can include a database such as a data warehouse 154.

In some cases, there can be payment card accounts that do not have physical cards or other physical payment devices associated therewith; for example, a customer can be provided with a PAN, expiration date, and security code, but no physical payment device, and use same, for example, for card-not-present telephone or internet transactions. Data from such accounts can optionally be used for estimating the potential benefit of funding a special account, such as an HSA or FSA, in one or more embodiments, to the extent that purchases qualifying for such a special account could be made via a payment card account that does not have a physical card or other physical payment device associated therewith.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator of a payment network 2008 configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the consumer 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the payment card network 2008, which debits the issuers 2010 for payment and credits the acquirer 2006. Once the acquirer 2006 has been paid, the acquirer 2006 pays the merchant 2004.

Transaction database 2021 is discussed below.

It will be appreciated that the payment card network 2008 shown in FIG. 2 is an example of a payment network configured to facilitate transactions between multiple issuers and multiple acquirers, which may be thought of as an “open” system. Some embodiments of the disclosure may be employed in connection with data from payment card account transactions using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the ISO Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN) (which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. Nos. 6,636,833 and 7,136,835 of Flitcroft et al., the complete disclosures of both of which are expressly incorporated herein by reference in their entireties for all purposes.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network.

In one or more embodiments, based on the past purchase activity on a payment card account (a credit card account is a non-limiting example), or on other suitable data, an estimation is made of the amount of spending that likely qualifies for payment through a special account, such as an HSA or FSA. This information is made available to a cardholder or other interested individual and/or used to help make decisions about how much money to place in the cardholder's (or other individual's) HSA, FSA, and/or other special account; for example, during annual enrollment. This is advantageous since underfunding such a special account fails to take full advantage of its benefits, while overfunding of such an account may render the excess funds unavailable for other needs or even result in their forfeiture if not used.

Thus, in one or more embodiments, examine past purchase activity on a cardholder's payment card, or other suitable data, and estimate what the eligible purchases would likely be under a special account such as an HSA or FSA, and provide some recommendation regarding how to fund such account(s). To accomplish this goal, for example, analyze the data in transaction database 2021 to identify:
purchases that appear to be fully covered; e.g., visits to a doctor's office;
purchases that may be partially covered; e.g., purchases at a pharmacy that sells both ineligible products, such as soft drinks, and eligible products, such as prescription medications;
at least implicitly, ineligible purchases (i.e., if fully and partially covered purchases are identified, the remainder are implied to be fully ineligible).

With regard to the second bullet point, to address the issue of merchants (e.g., pharmacies) where some purchases are eligible and some purchases not eligible, some embodiments apply a factor to total spending in such environments. For example, from known data, determine a scaling factor; i.e., that some fraction or percentage “X” of purchases in such environments is eligible; then, take that fraction or percentage of the total spending for the cardholder's payment card accounts account in such environments, and assume that much to be eligible. For example, if “X” is 20% and the total spending (e.g., for one year) at pharmacies is $1000, assume $200 is eligible.

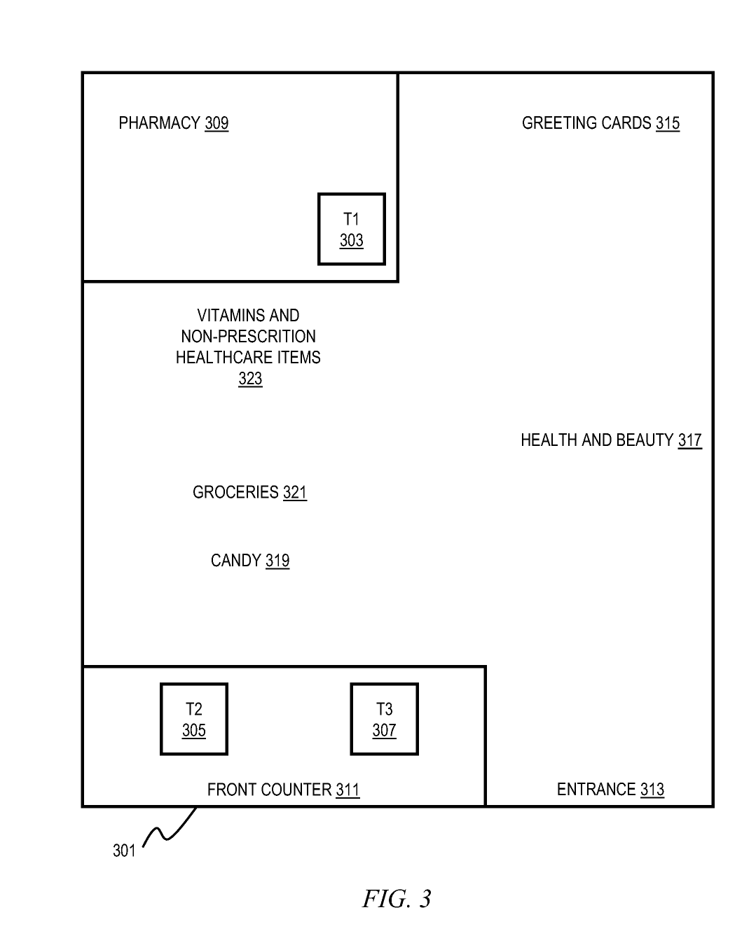

Another way to address the issue of merchants where some purchases are eligible and some purchases not eligible includes seeking to estimate which purchases are eligible and which are ineligible based on what counter within a store the purchase occurs at. Refer to FIG. 3, which depicts an exemplary chain pharmacy store 301. The entrance is located at 313. The store sells a number of ineligible items, including greeting cards 315, health and beauty products 317, groceries 321, and candy 319. Also included are eligible items in pharmacy 309, and items, some of which may be eligible and some ineligible, such as vitamins and non-prescription healthcare items 323. Note that this is a non-limiting example and one or more embodiments are generally useful in connection with special accounts wherein some items are eligible and some are not eligible, regardless of the specific rules that determine eligibility in a particular implementation.

In the example of FIG. 3, there are three check-out terminals T1 303, T2 305, and T3 307. The former is located by pharmacy 309, while the latter two are located at a front check-out counter 311. Purchases at T2 and T3 are likely associated with ineligible purchases, while T1 is likely associated with covered purchases. For example, a person who buys candy 319 will likely check out at front counter 311, while a person who buys a prescription will likely check out at T1. Of course, this is not necessarily exact; for example, someone buying a greeting card might check out at 303; however, the correlation is sufficient to permit reasonable eligibility projections based on terminal location. In this drug store example, the card number, date, amount, and merchant name and address would be present in database 2021, and several different ways can be utilized to categorize the merchant into categories such as drug stores (as in this example) doctor's offices, prosthetics stores, or other eligible categories.

Still another way to address the issue of merchants where some purchases are eligible and some purchases not eligible includes predicting item-level data (e.g., stock-keeping units (SKUs) or universal product codes (UPCs)). Furthermore in this regard, one or more embodiments are employed in connection with payment card networks wherein item-level data (e.g., stock-keeping units (SKUs) or universal product codes (UPCs)) is not sent through the network and is not per se available in database 2021. However, in some instances, such item-level data may be predicted or inferred from other data that is present. That is to say, examine a record in database 2021 for a given purchase (transaction), and, based on some purchase details, estimate what has been purchased. This can be contextual in some embodiments. For example, if someone visits a doctor's office, and then the next thing the person does is to visit the pharmacy, it is likely the person bought eligible medicines.

Transaction database 2021 typically includes a plurality of records for a plurality of different account numbers (PANs) for a single brand of payment card products, MASTERCARD®-branded payment cards being a non-limiting example. Each record may include a plurality of different transactions; the record for each transaction may include, for example, a time stamp, some type of merchant identifier or classifier, transaction (i.e., merchant) location, and the amount. The ellipses indicate that each PAN has many transactions, and that there are many PANs. In the absence of item-level data, the merchant identifier or classifier can be used to estimate whether the amount for a given transaction is 100% eligible, 100% ineligible, or partially eligible (again, item-level data can be estimated in some instances, but is generally not per se present in the transaction data recorded in the database 2021). In some cases, the records in database 2021 do not include any information that allows for identifying the cardholder associated with the PAN, and/or contractual or other obligations do not permit access or use of such information. In such cases, the issuing bank typically has this information. Thus, in at least some cases, an operator of a payment network such as 2008 offers a service to the issuer, who makes recommendations available to the actual cardholder. Note, however, that this is a non-limiting example. In other instances for example, in cases of cardholder opt-in or other form of cardholder consent, the records in database 2021 do permit identifying the cardholder associated with the PAN.

A number of different ways can be used to identify or classify merchants, in one or more embodiments, for example:
merchant category code (MCC);
North American Industry Classification System (NAICS);
Global Industry Classification Standard (GICS);
internal (e.g., proprietary) industry code/super industry code/firmographics (firmographics are the characteristics of a business, analogous to demographics for people);
location-based information (e.g., address, geographic coordinates) in the database 2021;
data enhancements such as appended data (e.g., category codes and/or firmographics from a third party vendor such as Dun & Bradstreet (D&B)) which also provides a line of business.

Furthermore, in some instances, records in database 2021 include terminal information such as terminal identification that will identify a specific terminal in the store.

Thus, the operator of a payment network, such as 2008, can determine, or at least estimate, the line of business for the merchant in a given transaction in the database 2021, in many different ways. In a simple case, such as visiting a doctor's office, assume the spending is 100% covered by a special account, such as an HSA or FSA. As noted above, in the case of a drug store purchase, not everything that can be purchased in a drug store is eligible, and this can be addressed with a number of different techniques.

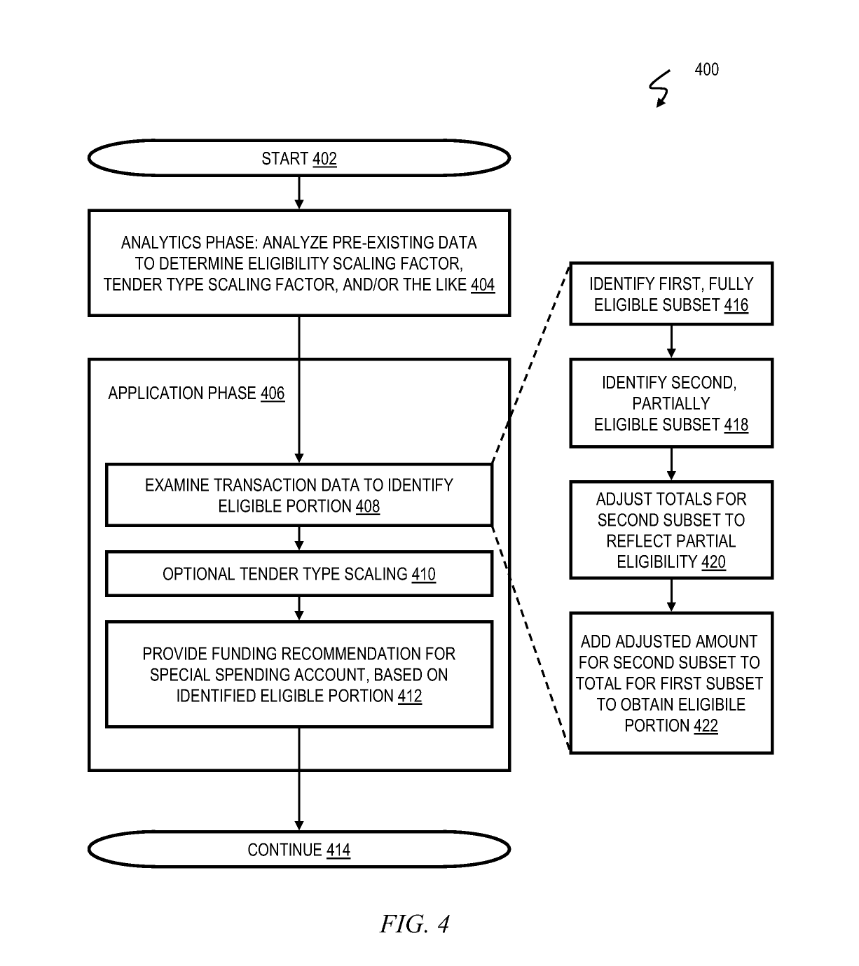

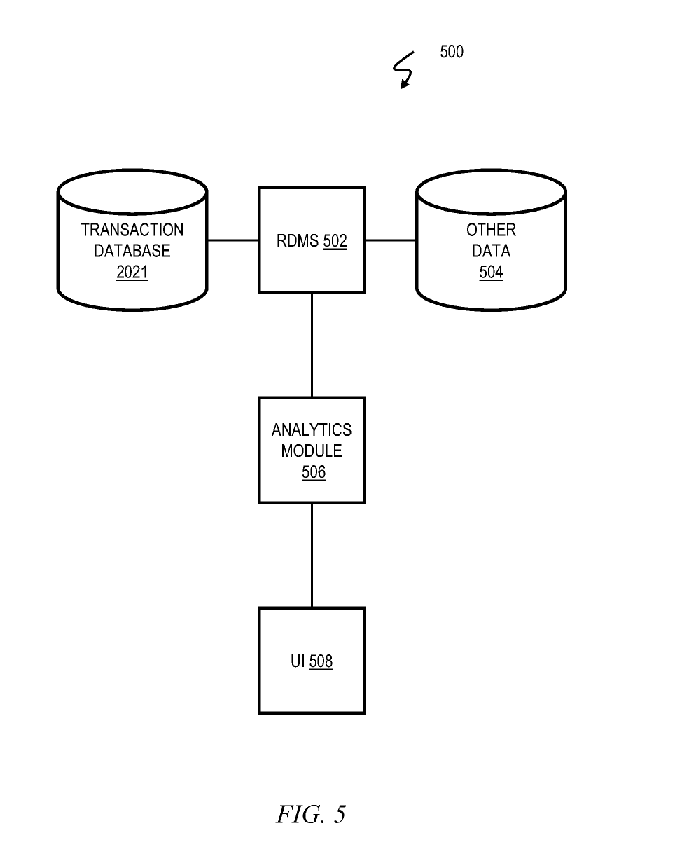

Referring to flow chart 400 of FIG. 4, which begins at 402, one or more embodiments employ a two-phase process. In a first (“analytic”) phase 404, use statistical analysis techniques to analyze available data (e.g., other data 504, as discussed below with reference to FIG. 5) and make pertinent conclusions about the data. For example, suppose it can be determined through historical analysis that X % (more generally, a suitable scaling factor) of drug store purchases are HSA-eligible. Determine this, for example, from a small sample of actual data or some other target or analytical methods. Another aspect that can be addressed during the analytics phase 404 is whether it is desirable to scale the data for other tender types. For example, the data in database 2021 is for a single brand of payment card; however, people can pay with cash, check, other brands of payment card products, and the like. In some cases, develop scaling factors during the analytic phase to scale up the data to account for people buying some things with cash, check, other brands of payment card products, and the like. In some cases, cardholders are prompted to perform their own scaling. Scaling can involve, for example, one, some, or all of the following, for a given individual:
scaling from a single payment card account of a given brand to an estimate for all accounts of that brand (e.g., John Smith has a MasterCard-branded payment card account with ACME Bank as the issuer; based on data for that account, scale up to estimate the total for all John Smith's MasterCard accounts with all issuers);
scaling from a single payment card account of a given brand to an estimate for all payment card accounts of any brand (e.g., John Smith has a MasterCard-branded payment card account with ACME Bank as the issuer; based on data for that account, scale up to estimate the total for all John Smith's payment card accounts);
scaling from a single payment card account of a given brand to all forms of payment (e.g., payment card, cash, check) (e.g., John Smith has a MasterCard-branded payment card account with ACME Bank as the issuer; based on data for that account, scale up to estimate the total for all John Smith's payments with any form of payment);
scaling from all accounts of a given brand to an estimate for all payment card accounts of any brand (e.g., John Smith has one or more MasterCard-branded payment card accounts; based on data for these one or more accounts, scale up to estimate the total for all John Smith's payment card accounts);
scaling from all accounts of a given brand to an estimate for all forms of payment (e.g., payment card, cash, check) (e.g., John Smith has one or more MasterCard-branded payment card accounts; based on data for these one or more accounts, scale up to estimate the total for all John Smith's payments with any form of payment).

In a second (“application”) phase 406, apply the conclusions from the analytical phase to the data in the database 2021.

Continued reference should be had to the flow chart 400 of FIG. 4, as well as to the exemplary block diagram 500 of FIG. 5. Given the discussion thus far, it will be appreciated that, in general terms, an exemplary method, in accordance with an aspect of the disclosure, includes the step 408 of examining transaction data from a set of transactions (in a non-limiting example, the transactions are for a payment card account as stored in transaction database 2021) to identify a portion of spending in the set of transactions which is eligible for coverage by a special spending account. The set of transactions were not made with the special spending account. Where the transactions are for a payment card account, the special spending account is separate and distinct from the payment card account; for example, the payment card account is an ordinary credit, debit, or stored value account that can be used to purchase anything, while the special spending account has a different account number and can only be used to purchase eligible items.

In a non-limiting example, step 408 can be carried out via a suitable database program, such as relational database management system (RDMS) 502, querying database 2021; optionally with further analysis or processing using analytics module 506. The analytics module can include, for example, a spreadsheet that interfaces with the database(s); custom-written code (e.g., high level) that takes the results of the database queries as an input; an analytical package such as SAS Visual Analytics software available from SAS Institute, Inc., Cary, N.C., US that takes the results of the database queries as an input; visualization software; business intelligence tools; or an in-database analytics package such as the DB Lytix package available from Fuzzy Logix, LLC Charlotte, N.C., USA. In some instances, a web interface can be used.

As noted, the transactions, in one or more embodiments, are for a payment card account and the transaction data is in transaction database 2021. However, other kinds of transaction data could be used. For example, an individual could provide a list of his or her past transactions for some time period that he or she believed to include transactions putatively eligible for the special spending account. In another aspect, data could be mined from an on-line bill payment system (optionally with bill presentment functionality); a non-limiting example is the MasterCard RPPS® electronic payment system of MasterCard International Incorporated of Purchase, N.Y., USA. This example is non-limiting; for example, other types of electronic bill presentment and/or payment systems could be employed in other instances. Non-limiting examples are is described in:
US Patent Publication 2011-0251952 A1 of Mary L. Kelly et al.;
US Patent Publication 2012-0197788 A1 of Hemal Sanghvi et al.

The above-listed Kelly and Sanghvi publications are hereby expressly incorporated by reference herein in their entireties for all purposes. Note that in some instances, data from such a system may not relate to individual purchases, but rather, to paying off payment card or utility bills or the like, and so may not be ideal in connection with one or more embodiments. However, data from such a system could be useful, for example, where it reflected payments to an on-line pharmacy.

Optional step 410 is discussed below.

A further step 412 includes providing a funding recommendation for the special spending account, based on the identified portion of the spending in the set of transactions which is eligible for the coverage by the special spending account. In a non-limiting example, this step 412 can be carried out with analytics module 506.

As used herein, a “special account” is an account that can be used to pay for some goods or services (“eligible items”) but not for other goods or services (“ineligible items”). Some special accounts do not allow withdrawing money once placed in the account. Some special accounts result in loss of money placed in the account if not used in a predetermined time period. Some special accounts are tax-advantaged, in that money placed into the accounts from wages is not taxed.

As seen at 416, 418, 420, 422, in some cases, the examining 408 includes, as at 416, identifying a first subset of the transactions having spending that is likely fully eligible for the coverage by the special spending account. In some cases, this step is carried out by having RDMS 502 query database 2021, optionally with use of analytics module 506. In step 418, identify a second subset of the transactions having spending likely only partially eligible for the coverage by the special spending account. In some cases, this step is carried out by having RDMS 502 query database 2021, optionally with use of analytics module 506. In step 420, adjust the total spending amount of the second subset of the transactions to reflect the partial eligibility, to obtain an adjusted spending amount associated with the second subset of the transactions. In some cases, this step is carried out by analytics module 506. In step 422, add the adjusted spending amount associated with the second subset of transactions to the total spending amount of the first subset of transactions to obtain the portion of spending in the set of transactions which is eligible for coverage by the special spending account. In some cases, this step is carried out by analytics module 506.

In a non-limiting example, step 416 includes identifying merchants associated with the first subset of the transactions as merchants providing at least one of goods and services likely fully eligible for the coverage by the special spending account. In some cases, this step is carried out by having RDMS 502 query database 2021. In a non-limiting example, step 418 includes identifying merchants associated with the second subset of the transactions as merchants providing at least one of goods and services likely only partially eligible for the coverage by the special spending account. In some cases, this step is carried out by having RDMS 502 query database 2021. Different types of merchant identification and/or classification have been discussed above.

In some cases, step 420 includes applying an eligibility scaling factor to the total spending amount of the second subset of the transactions. Refer to the pharmacy X % example above. In some cases, this step is carried out by analytics module 506.

In some cases, step 420 includes identifying, within the second subset of transactions, only those transactions associated with terminals (e.g., T1) likely to have transactions fully eligible for the coverage by the special spending account. In some cases, this step is carried out by having RDMS 502 query database 2021.

In some cases, step 420 includes predicting item-level details for at least one of products and services purchased in the second subset of the transactions, and including in the adjusted spending amount only spending for item-level details associated with eligible products or services, respectively. In some cases, this step is carried out by analytics module 506.

Optionally, in step 412, as seen at 410, the funding recommendation is further based on scaling the identified portion of the spending in the set of transactions which is eligible for the coverage by the special spending account to take into account other tender types. In some cases, this step is carried out by analytics module 506. Non-limiting examples of various types of tender scaling are discussed above; refer also to unpublished U.S. patent application Ser. No. 14/048,958 of Debashis Ghosh and Randy Shuken, entitled “APPARATUS, METHOD, AND COMPUTER PROGRAM PRODUCT FOR TENDER TYPE SCALING USING AN ON-LINE BILL PAYMENT PLATFORM,” filed 8 Oct. 2013, and expressly incorporated herein by reference in its entirety for all purposes.

As noted, in some instances, in an analytics phase 404, analyze pre-existing data 504 to determine, for example, one or more of an eligibility scaling factor (X) to apply to the total spending amount of the second subset of transactions; and a tender type scaling factor to be used in step 410 to scale the identified portion of the spending in the set of transactions which is eligible for coverage by the special spending account to take into account other tender types. In some cases, this step 404 can be carried out via a suitable database program, such as relational database management system (RDMS) 502, querying database 2021 and/or database 504; optionally with further analysis or processing using analytics module 506. In some instances, analytics phase 404 utilizes transaction data from database 2021 as a generic data source. Specialized data sets in database 504 can also be used in some instances. In some cases, scaling factors, MCC tables, and the like, can be stored in database 504 for subsequent use. Note that in some cases, some or all of the contents of database 504 can be included in database 2021 instead.

In some cases, step 408 includes examining for a time period equal in length to the time period for which the special spending account is to be funded. For example, look at a one-year period in the past to predict how much to fund the account for in the upcoming year. In some cases, this step is carried out by having RDMS 502 query database 2021 based on a range of time stamps.

On the other hand, in some cases, step 408 includes examining for a time period that is not equal in length to the time period for which the special spending account is to be funded, and adjusting the eligible portion to account for the time period for which the transaction data is examined not being equal in length to the time period for which the special spending account is to be funded. For example, look at less or more than one year in the past and pro-rate to predict how much to fund the account for in the upcoming year. If a six-month period was examined, the result could be multiplied by two to obtain a full year prediction. If a two-year period was examined, the result could be divided by two to obtain a single-year prediction. In some cases, this step is carried out by having RDMS 502 query database 2021 based on a range of time stamps, and then using analytics module 506 to pro-rate.

Again, the total amount of spending for a given account during a given time period can be determined by running a query on database 2021 to identify all the records for that account number with a time stamp during the time period of interest, and then the amount for each of these records can be summed up. In general, queries to database 2021 can be, for example, on account number, time stamp, merchant identifier, amount, location, terminal ID, or enhanced or appended data, or any desired ranges or combinations thereof.

Processing continues at 414.

Note that system 500, in at least some cases, also includes a suitable user interface (UI) 508. One example of such a user interface is hypertext markup language (HTML) code served out by a server operated by entity 2008 or the like, to a personal computer, tablet, smart phone, or other device of a user who wishes to estimate funding for his or her special account. The html is parsed by a browser on the user's computer or other device to create a graphical user interface (GUI). In some cases, entity 2008 may operate a service for an issuer 2010 or the like and the UI 508 involves an application program interface (API) or the like that provides the issuer with visibility into the results of method 400; the user in such cases may interact, for example, with a GUI provided by the issuer.

As noted, one or more embodiments of the disclosure or elements thereof can be implemented in the form of a computer program product including a tangible computer readable recordable storage medium with computer usable program code for performing the method steps indicated stored thereon in a non-transitory manner (the code includes instructions which, when loaded into a memory, configure a processor coupled to the memory to be operative to carry out the method steps).

Furthermore, as noted, one or more embodiments of the disclosure or elements thereof can be implemented in the form of a system (or apparatus) including a memory and at least one processor that is coupled to the memory and operative to perform exemplary method steps; for example, when instructions are loaded into the memory to configure the processor.

Yet further, as noted, in another aspect, one or more embodiments of the disclosure or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means. The means for examining transaction data include, for example, the queries from RDMS 502 which query for records in database 2021 having records as described above, for example, with regard to sub-steps 416, 418, and/or 420; and the analytics module 506 implementing the algorithms discussed with regard to sub-steps 420 and/or 422. The means for providing a funding recommendation for the special spending account include, for example, the analytics module 506 implementing a suitable algorithm; e.g., provide the eligible portion if the time period examined is the same as the funding time period; else pro-rate the eligible portion as described elsewhere herein.

### System and Article of Manufacture Details

Embodiments of the disclosure can employ hardware and/or hardware and software aspects. Software includes, but is not limited to, firmware, resident software, microcode, etc. Software might be employed, for example, in connection with one or more of queries to databases 2021, 504; a terminal 122, 124, 125, 126; a reader module 132; a host, server, and/or processing center 140, 142, 144 (optionally with data warehouse 154) of a merchant, issuer, acquirer, processor, or operator of a network 2008, operating according to a payment system standard (and/or specification); and the like. Firmware might be employed, for example, in connection with payment devices such as cards 102, 112, as well as reader module 132.

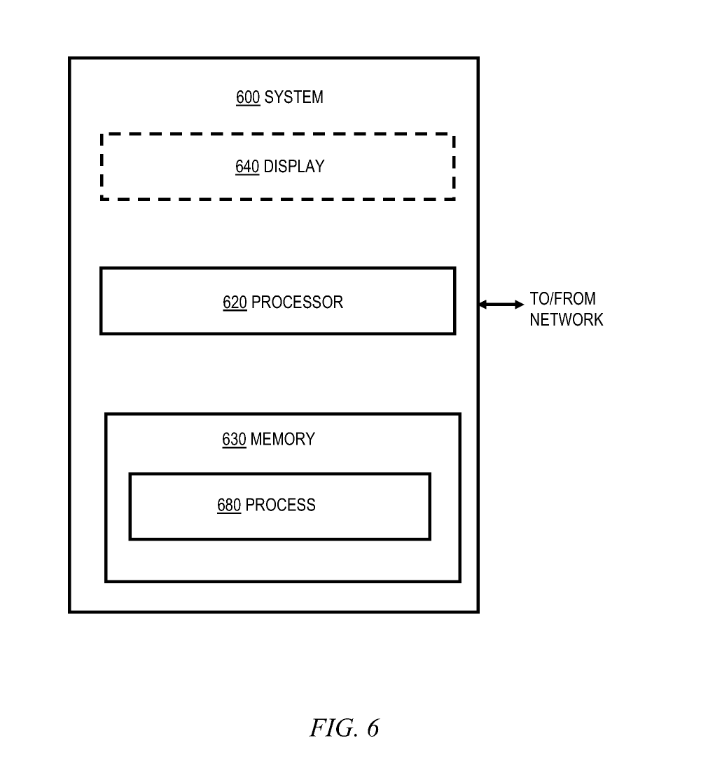

FIG. 6 is a block diagram of a system 600 that can implement part or all of one or more aspects or processes of the disclosure. As shown in FIG. 6, memory 630 configures the processor 620 (which could correspond, e.g., to processor portions 106, 116, 130; a processor of a terminal or a reader module 132; processors of remote hosts in centers 140, 142, 144; processors of hosts and/or servers implementing various functionality such as that for querying databases 2021 and/or 504; a processor of a server implementing RDMS 502 and/or analytics module 506; and the like); to implement one or more aspects of the methods, steps, and functions disclosed herein (collectively, shown as process 680 in FIG. 6). Different method steps can be performed by different processors. The memory 630 could be distributed or local and the processor 620 could be distributed or singular. The memory 630 could be implemented as an electrical, magnetic or optical memory, or any combination of these or other types of storage devices (including memory portions as described above with respect to cards 102, 112). It should be noted that if distributed processors are employed, each distributed processor that makes up processor 620 generally contains its own addressable memory space. It should also be noted that some or all of computer system 600 can be incorporated into an application-specific or general-use integrated circuit. For example, one or more method steps could be implemented in hardware in an ASIC rather than using firmware. Display 640 is representative of a variety of possible input/output devices (e.g., displays, printers, keyboards, mice, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a server or processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010; on a computer interacting with databases 2021, 504 and/or implementing RDMS 502 and/or analytics module 506; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the disclosure, such as, for example, 122, 124, 125, 126, 140, 142, 144, 2004, 2006, 2008, 2010; a computer interacting with databases 2021, 504 and/or implementing RDMS 502 and/or analytics module 506, and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 600 as shown in FIG. 6) running a server program. It will be understood that such a physical server may or may not include a display, keyboard, or other input/output components. A “host” includes a physical data processing system (for example, system 600 as shown in FIG. 6) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include a database module, such as a relational database management system module accessing database 2021 and/or database 504; an analytics module 506; and a user interface module 508. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the disclosure can be implemented, for example, by one or more appropriately programmed general purpose computers, such as, for example, servers or personal computers, located at one or more of the entities in the figures, as well as within the payment network 2008. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as relational database applications (e.g., IBM DB2® software available from International Business Machines Corporation, Armonk, N.Y., US; SAS® software available from SAS Institute, Inc., Cary, N.C., US), spreadsheets (e.g., Microsoft EXCEL® software available from Microsoft Corporation, Redmond, Wash., US), and the like. The computers can be programmed to implement the logic and/or data flow depicted in the figures. In some instances, messaging and the like may be in accordance with the ISO Specification 5583 Financial transaction card originated messages—Interchange message specifications and/or the ISO 20022 or UNIFI Standard for Financial Services Messaging, also incorporated herein by reference in its entirety for all purposes.

Although illustrative embodiments of the disclosure have been described herein with reference to the accompanying drawings, it is to be understood that the disclosure is not limited to those precise embodiments, and that various other changes and modifications may be made by one skilled in the art without departing from the scope or spirit of the disclosure.

What is claimed is:

1. A method comprising the steps of:
examining transaction data from a set of transactions to identify a portion of spending in said set of transactions which is eligible for coverage by a special spending account, said set of transactions not being made with said special spending account; and
providing a funding recommendation for said special spending account, based on said identified portion of said spending in said set of transactions which is eligible for said coverage by said special spending account.

2. The method of claim 1, wherein, in said examining step:
said set of transactions is for a payment card account; and
said special spending account is separate and distinct from said payment card account.

3. The method of claim 2, wherein said examining comprises:
identifying a first subset of said transactions having spending likely fully eligible for said coverage by said special spending account;
identifying a second subset of said transactions having spending likely only partially eligible for said coverage by said special spending account;
adjusting a total spending amount of said second subset of said transactions to reflect said partial eligibility, to obtain an adjusted spending amount associated with said second subset of said transactions; and
adding said adjusted spending amount associated with said second subset of said transactions to a total spending amount of said first subset of said transactions to obtain said portion of spending in said set of transactions which is eligible for coverage by said special spending account.

4. The method of claim 3, wherein:
said identifying of said first subset of said transactions comprises identifying merchants associated with said first subset of said transactions as merchants providing at least one of goods and services likely fully eligible for said coverage by said special spending account; and
said identifying of said second subset of said transactions comprises identifying merchants associated with said second subset of said transactions as merchants providing at least one of goods and services likely only partially eligible for said coverage by said special spending account.

5. The method of claim 4, wherein said adjusting comprises applying an eligibility scaling factor to said total spending amount of said second subset of said transactions.

6. The method of claim 4, wherein said adjusting comprises identifying, within said second subset of said transactions having spending likely only partially eligible for said coverage by said special spending account, only those transactions associated with terminals likely to have transactions fully eligible for said coverage by said special spending account.

7. The method of claim 4, wherein said adjusting comprises predicting item-level details for at least one of products and services purchased in said second subset of said transactions, and including in said adjusted spending amount only spending for item-level details associated with eligible products or services, respectively.

8. The method of claim 4, wherein, in said providing of said funding recommendation for said special spending account, said funding recommendation is further based on scaling said identified portion of said spending in said set of transactions which is eligible for said coverage by said special spending account to take into account other tender types.

9. The method of claim 4, further comprising analyzing pre-existing data to determine at least one of:
an eligibility scaling factor to apply to said total spending amount of said second subset of said transactions; and
a tender type scaling factor to scale said identified portion of said spending in said set of transactions which is eligible for said coverage by said special spending account to take into account other tender types.

10. The method of claim 2, wherein said examining of said transaction data comprises examining for a time period equal in length to a time period for which said special spending account is to be funded.

11. The method of claim 2, wherein said examining of said transaction data comprises examining for a time period not equal in length to a time period for which said special spending account is to be funded, and adjusting said portion of said spending in said set of transactions which is eligible for said coverage by said special spending account to account for said time period for which said transaction data is examined not being equal in length to said time period for which said special spending account is to be funded.

12. The method of claim 1, further comprising providing a system, wherein the system comprises distinct software modules, each of the distinct software modules being embodied on a non-transitory computer-readable storage medium, and wherein the distinct software modules comprise a database module and an analytics module;
wherein:
said examining of said transaction data is carried out by at least said database module executing on at least one hardware processor; and
said providing of said funding recommendation is carried out by said analytics module executing on said at least one hardware processor.

13. A system comprising:
a memory;
at least one processor operatively coupled to said memory; and
a non-transitory persistent storage device operatively coupled to said memory and storing instructions which when loaded into said memory cause said at least one processor to be operative to:
examine transaction data from a set of transactions to identify a portion of spending in said set of transactions which is eligible for coverage by a special spending account, said set of transactions not being made with said special spending account; and
provide a funding recommendation for said special spending account, based on said identified portion of said spending in said set of transactions which is eligible for said coverage by said special spending account.

14. The system of claim 13, wherein:
said set of transactions is for a payment card account; and
said special spending account is separate and distinct from said payment card account.

15. The system of claim 14, wherein said at least one processor is operative to examine by:
identifying a first subset of said transactions having spending likely fully eligible for said coverage by said special spending account;
identifying a second subset of said transactions having spending likely only partially eligible for said coverage by said special spending account;
adjusting a total spending amount of said second subset of said transactions to reflect said partial eligibility, to obtain an adjusted spending amount associated with said second subset of said transactions; and
adding said adjusted spending amount associated with said second subset of said transactions to a total spending amount of said first subset of said transactions to obtain said portion of spending in said set of transactions which is eligible for coverage by said special spending account.

16. The system of claim 15, wherein:
said at least one processor is operative to identify said first subset of said transactions by identifying merchants associated with said first subset of said transactions as merchants providing at least one of goods and services likely fully eligible for said coverage by said special spending account; and
said at least one processor is operative to identify said second subset of said transactions by identifying merchants associated with said second subset of said transactions as merchants providing at least one of goods and services likely only partially eligible for said coverage by said special spending account.

17. The system of claim 16, wherein said at least one processor is operative to adjust by applying an eligibility scaling factor to said total spending amount of said second subset of said transactions.

18. The system of claim 16, wherein said at least one processor is operative to adjust by identifying, within said second subset of said transactions having spending likely only partially eligible for said coverage by said special spending account, only those transactions associated with terminals likely to have transactions fully eligible for said coverage by said special spending account.

19. The system of claim 16, wherein said at least one processor is operative to adjust by predicting item-level details for at least one of products and services purchased in said second subset of said transactions, and including in said adjusted spending amount only spending for item-level details associated with eligible products or services, respectively.

20. The system of claim 16, wherein said at least one processor is operative to further base said funding recommendation on scaling said identified portion of said spending in said set of transactions which is eligible for said coverage by said special spending account to take into account other tender types.

21. The system of claim 16, wherein said at least one processor is further operative to analyze pre-existing data to determine at least one of:
an eligibility scaling factor to apply to said total spending amount of said second subset of said transactions; and
a tender type scaling factor to scale said identified portion of said spending in said set of transactions which is eligible for said coverage by said special spending account to take into account other tender types.

22. The system of claim 14, wherein said at least one processor is operative to examine said transaction data for a time period equal in length to a time period for which said special spending account is to be funded.

23. The system of claim 14, wherein said at least one processor is operative to examine said transaction data for a time period not equal in length to a time period for which said special spending account is to be funded, and wherein said at least one processor is further operative to adjust said portion of said spending in said set of transactions which is eligible for said coverage by said special spending account to account for said time period for which said transaction data is examined not being equal in length to said time period for which said special spending account is to be funded.

24. The system of claim 14, wherein said instructions on said persistent storage device comprise distinct software modules, and wherein said distinct software modules comprise a database module and an analytics module;
wherein:
said database module comprises at least a portion of said instructions which cause said at least one processor to examine said transaction data; and
said analytics module comprises said instructions which cause said at least one processor to provide said funding recommendation.

25. An article of manufacture comprising a computer program product, said computer program product comprising:
a tangible computer-readable recordable storage medium, storing in a non-transitory manner computer readable program code comprising instructions which when loaded into a memory cause at least one processor coupled to said memory to be operative to:
examine transaction data from a set of transactions to identify a portion of spending in said set of transactions which is eligible for coverage by a special spending account, said set of transactions not being made with said special spending account; and
provide a funding recommendation for said special spending account, based on said identified portion of said spending in said set of transactions which is eligible for said coverage by said special spending account.

26. The article of manufacture of claim 25, wherein:
said set of transactions is for a payment card account; and
said special spending account is separate and distinct from said payment card account.

27. An apparatus comprising:
means for examining transaction data from a set of transactions to identify a portion of spending in said set of transactions which is eligible for coverage by a special spending account, said set of transactions not being made with said special spending account; and
means for providing a funding recommendation for said special spending account, based on said identified portion of said spending in said set of transactions which is eligible for said coverage by said special spending account.
